(19) United States
(12) Patent Application Publication
(10) Pub. No.: US 2017/0011647 A1
(43) Pub. Date: Jan. 12, 2017

(54) LASER MECHANISM AND LASER GUN FOR SHOOTING TRAINING

(71) Applicant: Kuo-Hao Huang, Changhua County (TW)

(72) Inventors: Kuo-Hao Huang, Changhua County (TW); Chih-Erh Wu, Taipei City (TW); Ya-Hui Chiu, Yilan County (TW)

(21) Appl. No.: 15/203,815

(22) Filed: Jul. 7, 2016

(30) Foreign Application Priority Data
Jul. 8, 2015 (TW) 104122147

(51) Int. Cl. G09B 9/00

(52) U.S. Cl. CPC G09B 9/003

(57) ABSTRACT

Disclosed is a laser mechanism for shooting training, which is coupled with a gun body and includes a laser assembly, a jointing assembly, and a pressing member. The laser assembly includes a laser emitter and a laser activator electrically connected with the laser emitter. The jointing assembly is detachably mounted in a gun barrel of the gun body. The pressing member is slidably arranged at a front end of the jointing assembly at a location adjacent to and corresponding to the laser activator. The pressing member receives a driving force applied from the gun body to act thereon to slide towards the laser activator and thus pressing against the laser activator, so as to cause the laser activator to trigger and activate the laser emitter to emit a laser beam. The driving force is a pneumatic driving force and/or a mechanical driving force.

### (a) TECHNICAL FIELD OF THE INVENTION

The present invention relates generally to a laser mechanism and a laser gun, and more particularly to a laser mechanism and a laser gun for shooting training.

### (b) DESCRIPTION OF THE PRIOR ART

Airsoft guns, specifically utilizing plastic pellets, or paintball guns are commonly used for shoot training or entertaining These airsoft guns or paintball guns have certain drawbacks. For example, loading/unloading and supply of plastic pellets pellets or paintballs are generally troublesome. In addition, after shooting, the plastic pellets would be easily spreaded over a large area. That makes them hard to find and collect for recycling or disposal. This would lead to a wasting of the plastic pellets or a pollution to the environment. After hitting, paintballs might cause severely pain and physically injury, and the stains on clothing would be troublesome to remove. Laser guns, external/internal addons, or replacement devices, that emit laser beams, had been in the market for years. They have no need to load/unload the plastic pellets or paintballs and thus save the troubles in recycling/disposing pellets or cleansing clothing However, most of commercial/consumer laser training guns, addons, or replacement devices do not provide simulated recoil actions to mimic shooting experience for users.

### SUMMARY OF THE INVENTION

The primary object of the present invention is to provide a laser mechanism for shooting training, which is coupled with a gun body. The laser mechanism comprises a laser assembly, a jointing assembly, and a pressing member. The laser assembly comprises a laser emitter and a laser activator electrically connected with the laser emitter. The jointing assembly is detachably mounted in a gun barrel of the gun body. The pressing member is slidably arranged at a front end of the jointing assembly at a location adjacent to and corresponding to the laser activator. The pressing member receives a driving force applied from the gun body to act thereon to slide towards the laser activator and thus pressing against the laser activator, so as to cause the laser activator to trigger and activate the laser emitter to emit a laser beam, wherein the driving force is a pneumatic driving force and/or a mechanical driving force.

Preferably, the jointing assembly comprises a stop section that is engageable with and thus stopping a stopped section of the pressing member in the sliding of the pressing member.

Preferably, the laser assembly is arranged in an extended jointing assembly, and the extended jointing assembly is coupled to coupling section of a front end of the jointing assembly and extends toward a muzzle of the gun barrel.

Preferably, the extended jointing assembly comprises a top lid and a bottom base, the laser assembly being fixed to the top lid and the bottom base by fasteners.

Preferably, the extended jointing assembly comprises a first positioning shell and a second positioning shell. The first positioning shell and the second positioning shell are coupled to and encompass the laser emitter so as to retain the laser emitter in position.

Preferably, the first positioning shell and the second positioning shell are interposed between a disposition tube and a sleeve.

Preferably, the jointing assembly has a hollow configuration and is in communication with the gun body to form a connection space.

Preferably, the jointing assembly comprises a positioning section, which is positionable against a positioning piece of the gun barrel.

Another object of the present invention is to provide a laser gun for shooting training. The laser gun comprises a gun body having a gun barrel in which the above-described laser mechanism is received and mounted.

Preferably, a driving piston is further included and provides, through mechanical contact or pressurized gas, the driving force to push the pressing member.

Preferably, a slidable pushing member is further included and is slidably arranged in the jointing assembly or is slidably arranged in a front opening of a connection space formed through communicating connection between the jointing assembly and the gun body. The slidable pushing member receives a gas flow from the connection space to act thereon so as to slide towards the pressing member to push the pressing member, wherein the gas flow is in the form of a positive pressure pneumatic pushing force or a negative pressure pneumatic suction force acting on the slidable pushing member.

Preferably, a pneumatic piston is further included and the pneumatic piston is connected with a slidable sleeve and acted by a pneumatic driving force to drive the slidable sleeve backwards.

The present invention helps save the troubles in recycling/disposing pellets, severely pain, physical injury, or cleansing clothing. With a laser mechanism being combinable with a gun barrel of any one of various gun bodies, a pressing member of the laser mechanism receives a driving force from the gun body to slide toward a laser activator and press against the laser activator in order to trigger and activate a laser emitter to emit a laser beam. Thus, the laser mechanism according to the present invention is mountable in a gun barrel of any one of various gun bodies to form a laser gun, so that the laser gun according to the present invention may resemble, in outside shape, quality, or shooting operation and user's perception, a genuine gun.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1A is a perspective view showing a laser mechanism according to an embodiment of the present invention.

FIG. 1B is an exploded view of the laser mechanism according to the embodiment of the present invention.

FIG. 1C is a cross-sectional view of the laser mechanism according to the embodiment of the present invention.

FIG. 1D is a cross-sectional view of the laser mechanism according to another embodiment of the present invention.

FIGS. 2A-2C are schematic views illustrating an operation of a laser gun according to a first embodiment of the present invention.

FIGS. 3A-3D are schematic views illustrating an operation of a laser gun according to a second embodiment of the present invention.

FIGS. 4A-4D are schematic views illustrating an operation of a laser gun according to a third embodiment of the present invention.

FIGS. 5A-5D are schematic views illustrating an operation of a laser gun according to a fourth embodiment of the present invention.

FIG. 6 is a schematic view illustrating an operation of a laser gun according to a fifth embodiment of the present invention.

FIGS. 7A and 7B are schematic views illustrating an operation of a laser gun according to a sixth embodiment of the present invention.

FIG. 8 is a schematic view illustrating an operation of a laser gun according to a seventh embodiment of the present invention.

FIG. 9 is a schematic view illustrating an operation of a laser gun according to an eighth embodiment of the present invention.

FIG. 10 is a schematic view illustrating an operation of a laser gun according to a ninth embodiment of the present invention.

FIG. 11 is a schematic view illustrating an operation of a laser gun according to a tenth embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

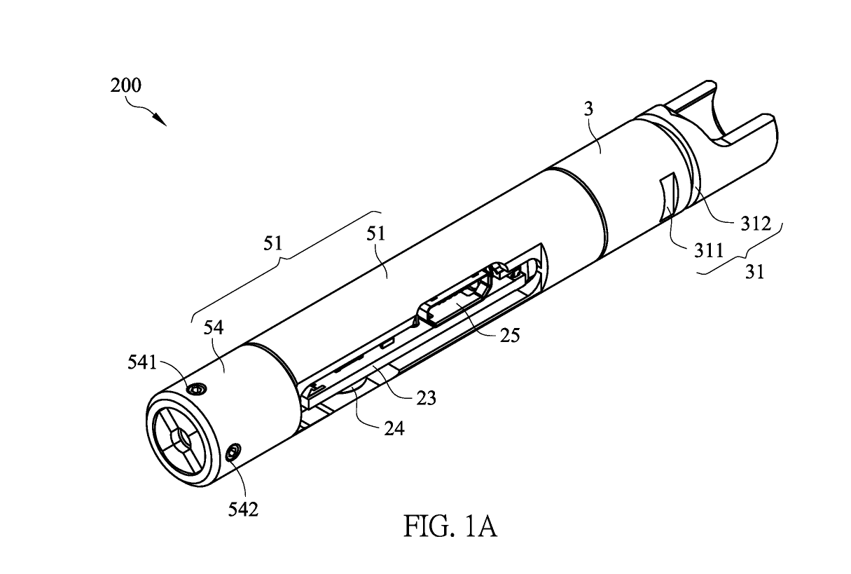

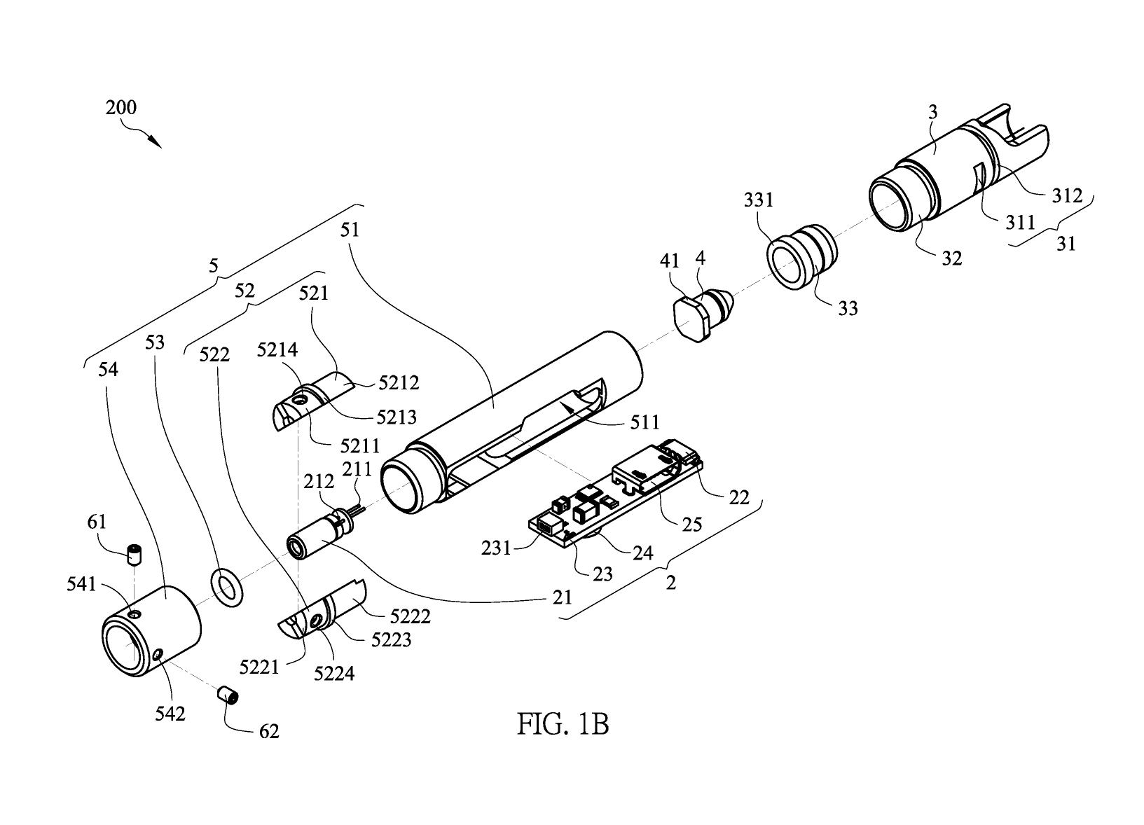

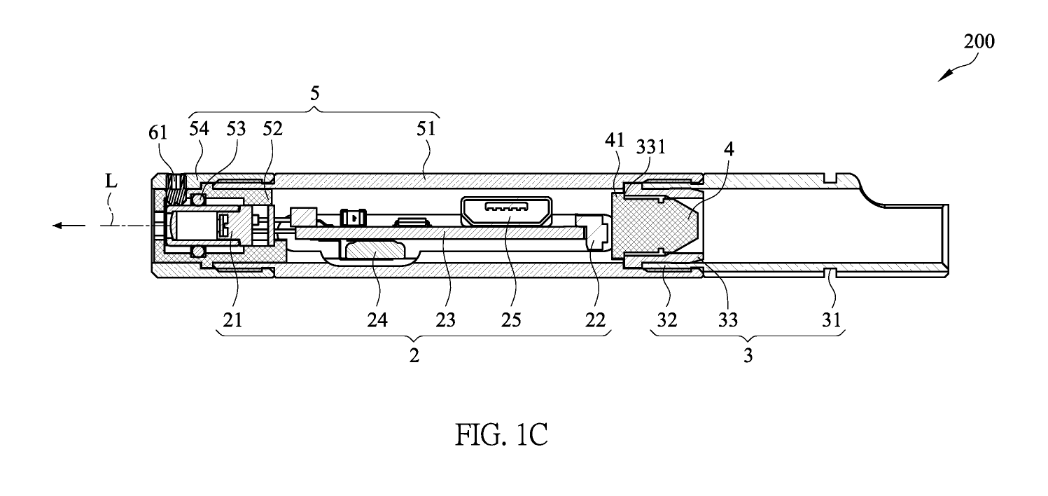

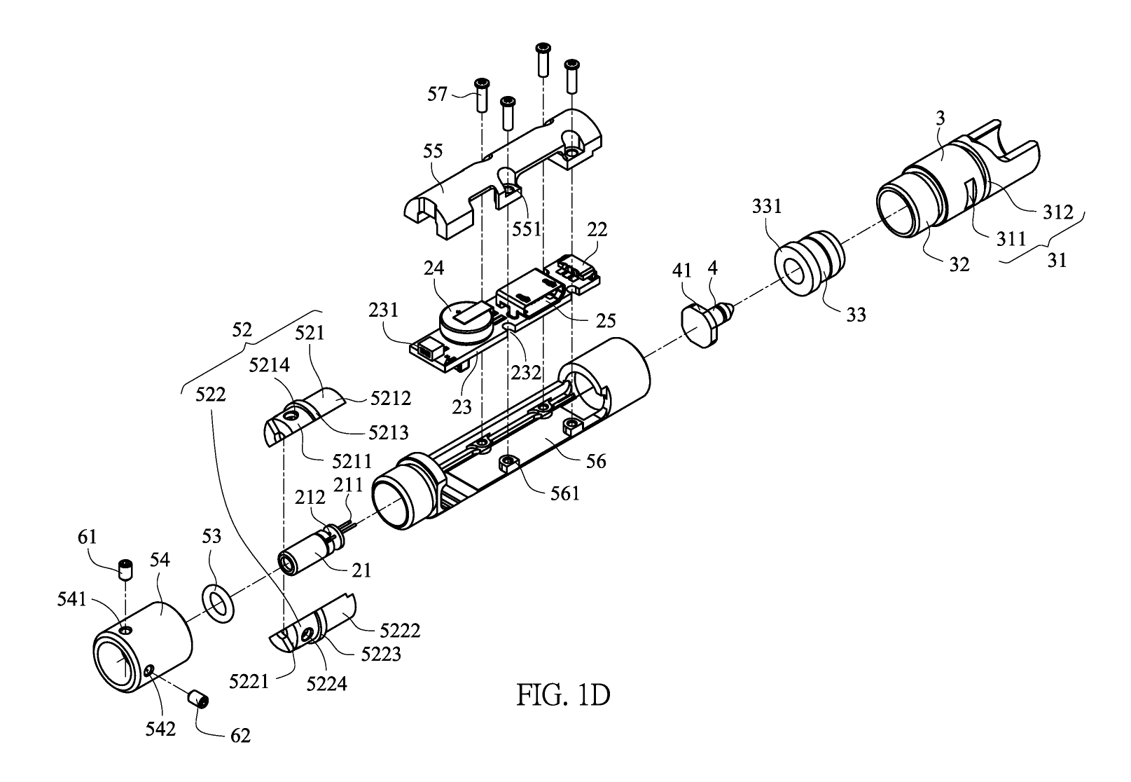

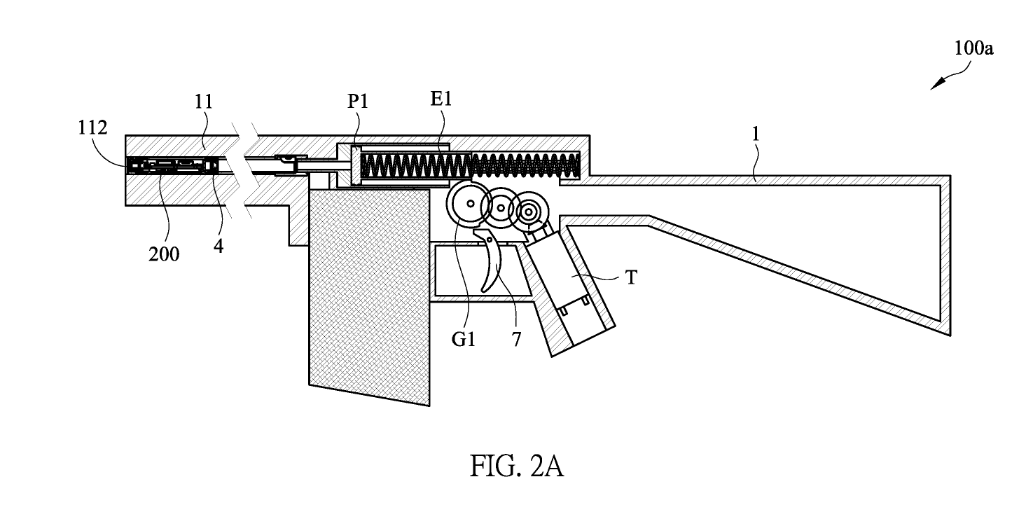

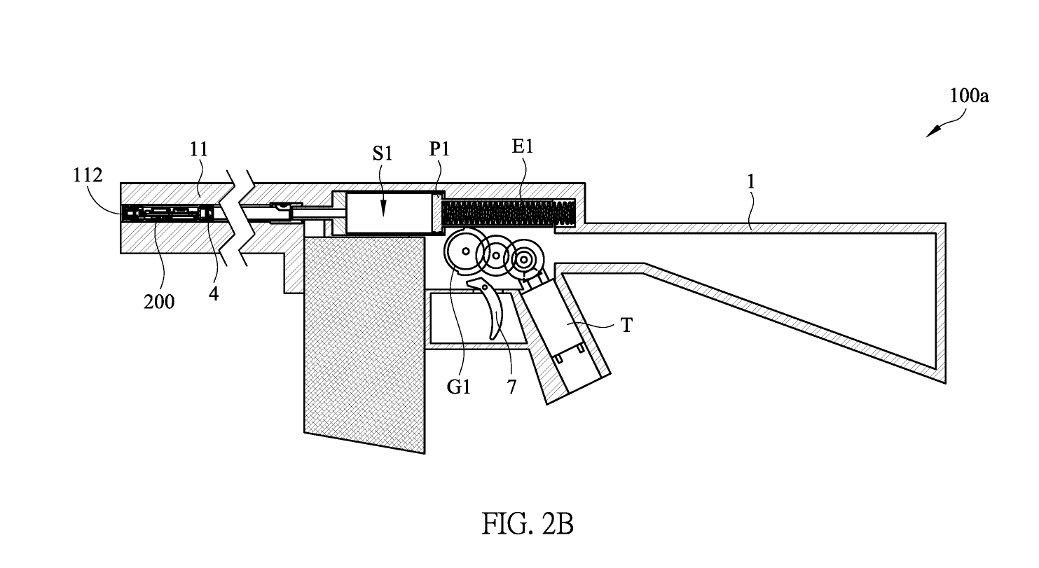

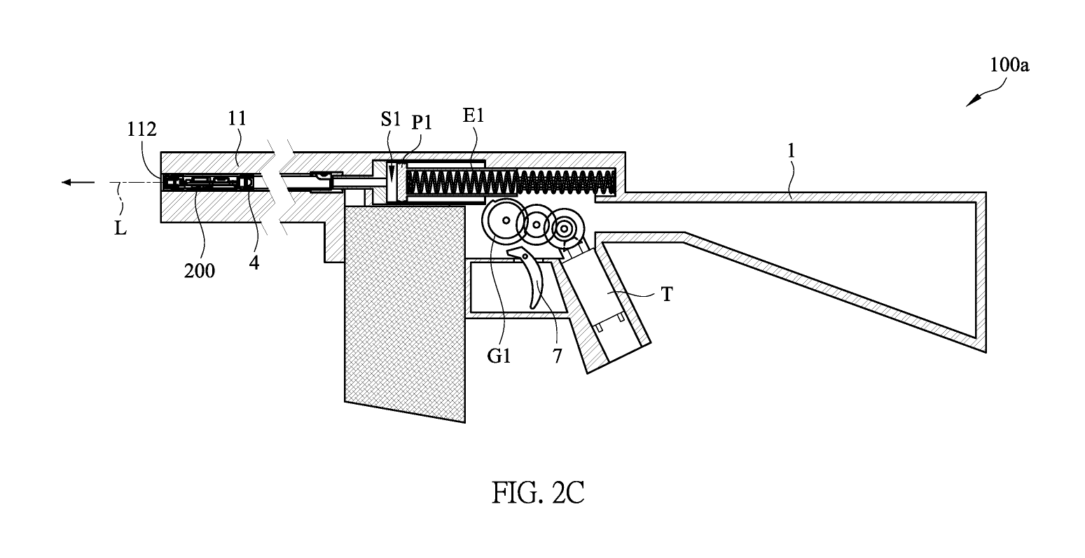

Referring to FIGS. 1A-1C, the present invention provides a laser mechanism, generally designated at 200, which is for shooting training and is coupled in a gun barrel 11 of a gun body 1 (as shown in FIGS. 2A-11). The laser mechanism 200 comprises a laser assembly 2, a jointing assembly 3, and a pressing member 4.

The laser assembly 2 comprises a laser emitter 21 and a laser activator 22 electronically connected with the laser emitter 21. In the instant embodiment, the laser emitter 21 has electronic terminal pins 211 that are inserted in a connection port 231 of a circuit board 23 to be electronically connected with the laser activator 22 that is also mounted on the circuit board 23. Preferably, the laser emitter 21 is located in a front section of the gun barrel 11. Preferably, the laser assembly 2 may comprise an electrical cell 24, which supplies electrical power necessary for operation of the laser assembly 2. The laser assembly 2 may further comprise a charging and communication connection port 25, so that the charging and communication connection port 25 can be used to electrically charge the electrical cell 24 or digital communication and/or identity recognition can be conducted through the laser assembly 2. More preferably, the laser assembly 2 may store transmission data in an electronic component provided on the circuit board 23 for further information processing for digital communication and/or identity recognition.

The jointing assembly 3 is detachably coupled in the gun barrel 11 of the gun body 1 (FIGS. 2A-11). In the instant embodiment, the jointing assembly 3 comprises a positioning section 31, which is positionable on the positioning piece of the gun barrel 11 (not shown). The positioning piece of the gun barrel 11 can be formed on an inside surface of the gun barrel 11 and is made in the form of a projection that corresponds to the positioning section 31. The positioning section 31 may comprise a first positioning section 311 and a second positioning section 312. Through engagement and positioning achieved between the first positioning section 311 and the positioning piece, rotation of the jointing assembly 3 is prevented and through engagement and positioning between the second positioning section 312 and the positioning piece, movement of the jointing assembly 3 in a lengthwise direction of the gun barrel 11 is prevented.

Preferably, the positioning piece is formed in a rear section of the gun barrel 11. The jointing assembly 3 is of a hollow configuration so that when the jointing assembly 3 is coupled or jointed, through the positioning piece, to the gun barrel 11 of the gun body 1, the jointing assembly 3 and the gun body 1 are in communication with each other to define a connection space. In the instant embodiment, the laser mechanism 200 further comprise an extended jointing assembly 5. The extended jointing assembly 5 is coupled to a coupling section 32 at a front end of the jointing assembly 3 and extends toward a muzzle 112 of the gun barrel 11 (FIGS. 2A-11). The laser assembly 2 is received and mounted in a disposition tube 51 of the extended jointing assembly 5. Preferably, the disposition tube 51 comprises a side opening 511, so that the laser assembly 2 can be disposed through the side opening 511 into the disposition tube 51. The laser assembly 2 can be mounted and fixed in the disposition tube 51 by means of snapping, fitting, and locking and so on. In other embodiments, the extended jointing assembly 5 comprises a top lid 55 and a bottom base 56. Fasteners 57 are set through holes 551 formed in the top lid 55 and holes 232 formed in the circuit board 23 to screw into and be fastened to fastening holes 561 formed in the bottom base 56 so as to have the laser assembly 2, the top lid 55, and the bottom base 56 securely fixed together thereby providing a securely and stably assembling effect, as shown in FIG. 1D.

It is noted that the laser emitter 21 is preferably located in the front section of the gun barrel 11 and the positioning piece 111 is preferably located in the rear section of the gun barrel 11 (meaning the laser mechanism 200 is preferably of a length approximately corresponding to the gun barrel 11). According to the present invention, the jointing assembly 3 and the extended jointing assembly 5 of the laser mechanism 200 can be manufactured separately such that each can be manufactured as various individual modules having different lengths. As such, by selecting and combining different modules of each of the jointing assembly 3 and the extended jointing assembly 5 having different lengths, the laser mechanism 200 provided in the present invention is adapted to guns having different lengths of gun barrel 11 (for example a long gun, such as a rifle, and a short gun, such as a pistol).

The pressing member 4 is slidably arranged at the front end of the jointing assembly 3 and at a location adjacent to and corresponding to the laser activator 22. The pressing member 4 may receive a driving force applied from the gun body 1 to be driven to slide toward the laser activator 22 and thus press against the laser activator 22, so as to cause the laser activator 22 to trigger and activate the laser emitter 21 such that the laser emitter 21 may emit a laser signal of which excitation time is controlled (to serve as a simple switch or to conduct and perform digital communication or to conduct and perform identity recognition) and which will be referred to as laser beam L hereafter, wherein the driving force can be a pneumatic driving force and/or a mechanical driving force. Further details regarding the driving force will be provided hereinafter.

To provide a limit to the sliding movement of the pressing member 4 and return to a home position after the driving force varnishes, in the instant embodiment, the jointing assembly 3 comprises a coupling head 33 that comprises a stop section 331, which at the moment when the pressing member 4 slides backwards, engages a stopped section 41 of the pressing member 4 to stop the movement thereof.

To stabilize a path of the laser beam L emitting from the laser emitter 21, in the instant embodiment, the extended jointing assembly 5 comprises a first positioning shell 521 and a second positioning shell 522, wherein the first positioning shell 521 and the second positioning shell 522 are coupled to and encompass the laser emitter 21 to fix the laser emitter 21 in position. For example, the laser emitter 21 may comprise a recessed section 212 (or a raised section), and the laser emitter 21, when coupled to and encompassed by the first positioning shell 521 and the second positioning shell 522, is positioned on a counterpart raised section (or a counterpart recessed section) formed in the first positioning shell 521 and the second positioning shell 522. Preferably, an O-ring 53 (such as a rubber ring) is provided between the laser emitter 21 and the combination of the first positioning shell 521 and the second positioning shell 522 so as to more stably fix the laser emitter 21 in position. In the instant embodiment, the first positioning shell 521 and the second positioning shell 522 are arranged to be interposed between the disposition tube 51 and a sleeve 54 in order to set the first positioning shell 521 and the second positioning shell 522 in position. In details, a front connection section 5211 of the first positioning shell 521 and a front connection section 5221 of the second positioning shell 522 are inserted into the sleeve 54, while are rear connection section 5212 of the first positioning shell 521 and a rear connection section 5222 of the second positioning shell 522 are inserted into the disposition tube 51. The front connection section 5211, 5221 and the rear connection section 5212, 5222 is separated from each other by a raised section 5213, 5223 formed therebetween. Further, the sleeve 54 and the front connection sections 5211, 5221 are respectively provided with locking holes 541, 542, 5214, 5224, so that a fastener 61 that is mounted in the locking hole 541 and extends through the locking hole 5214 and a fastener 62 that is coupled to the locking hole 542 and extends through the locking hole 5224 may position and couple the first positioning shell 521, the second positioning shell 522, and the sleeve 54 together and further, through minute positional adjustment of the fasteners 61, 62, an emission direction of the laser emitter 21 can be corrected to be exactly coincident with an aiming point.

Various examples or embodiment of the laser gun will be described hereinafter. In these embodiments of the laser gun, the gun barrel 11 of the gun body 1 receives and retains the above-described laser mechanism 200 disposed therein so that the pressing member 4 of the laser mechanism 200 may receive a driving force applied from the gun body 1 to slide toward the laser activator 22 and thus press against the laser activator 22, making the laser activator 22 trigger and activate the laser emitter 21 to cause the laser emitter 21 to emit a laser beam L.

Referring to FIGS. 2A-2C, in an embodiment, a laser gun 100a comprises a driving piston P1, which is driven by a piston driving toothed wheel G1 that comprises teeth successively distributed along a circumference thereof but not covering a complete circle of the circumference and is rotatably movable to drive, through a toothed section thereof, the piston to move, while a non-toothed section provides no operative engagement with the piston P1 to allow for free movement thereof As shown in FIG. 2A, an initial or home condition of the laser gun 100a is illustrated. Through pulling of a trigger plate 7 of the laser gun 100a, a power supply (not shown) is activated to make a driving motor T rotating and thus driving the piston driving toothed wheel G1 to rotate such that the toothed section drives the piston P1 to move backwards and thus compress a spring E1 connected to the driving piston P1, as shown in FIG. 2B. Afterwards, with the piston driving toothed wheel G1 being rotated to a position corresponding to the non-toothed section, where the piston P1 is released from engagement therewith and the spring E1 is allowed to push the piston P1 forwards from a maximum compression position. When the spring E1 pushes the driving piston P1 to move forwards, as shown in FIG. 2C, gas or air contained in the connection space S1 that is formed through communicating connection between the jointing assembly 3 and the gun body 1 is compressed and the compressed gas or air provides the driving force (which is a pneumatic driving force) to push the pressing member 4 for emission of the laser beam L.

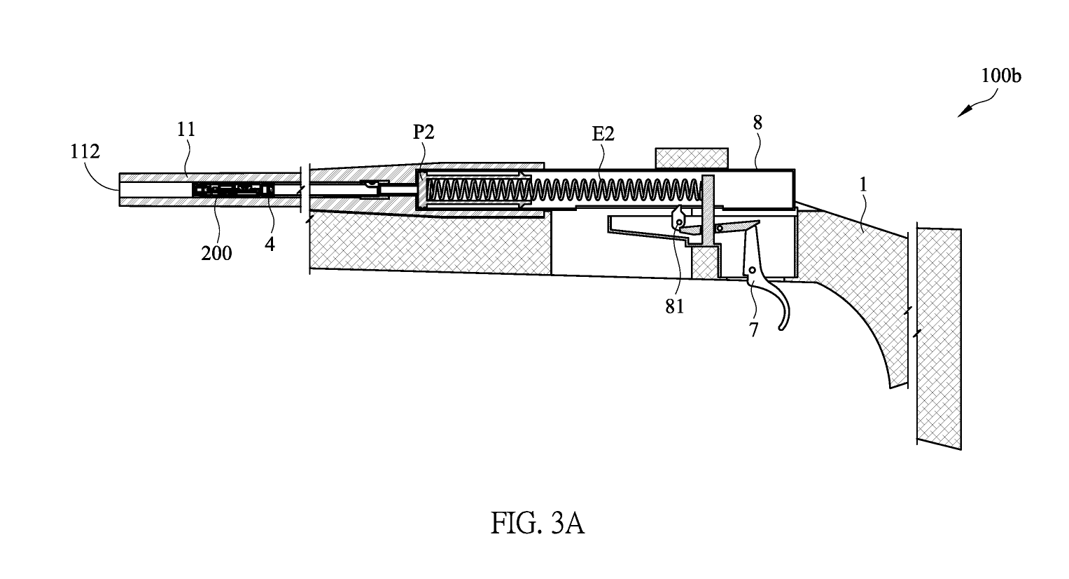

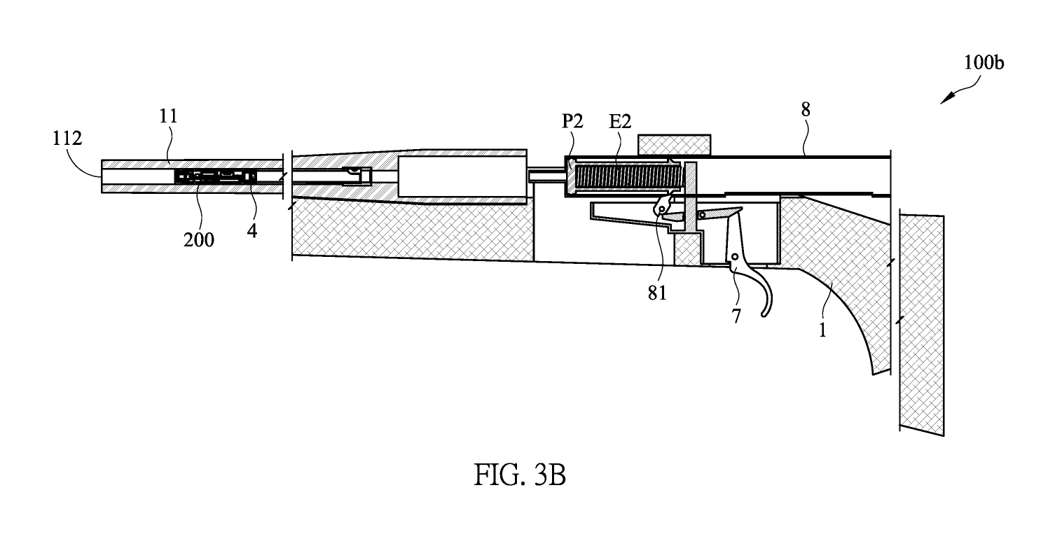

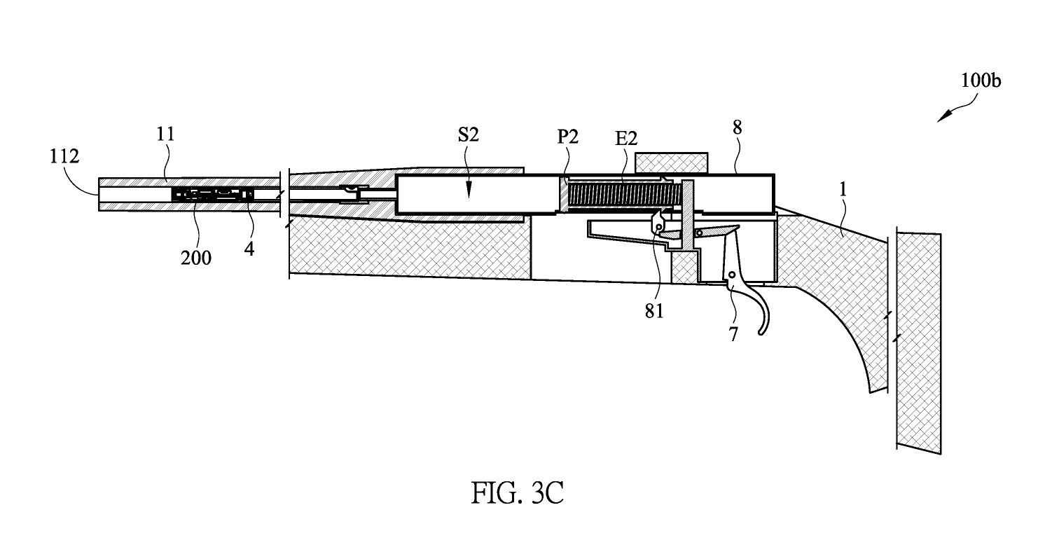

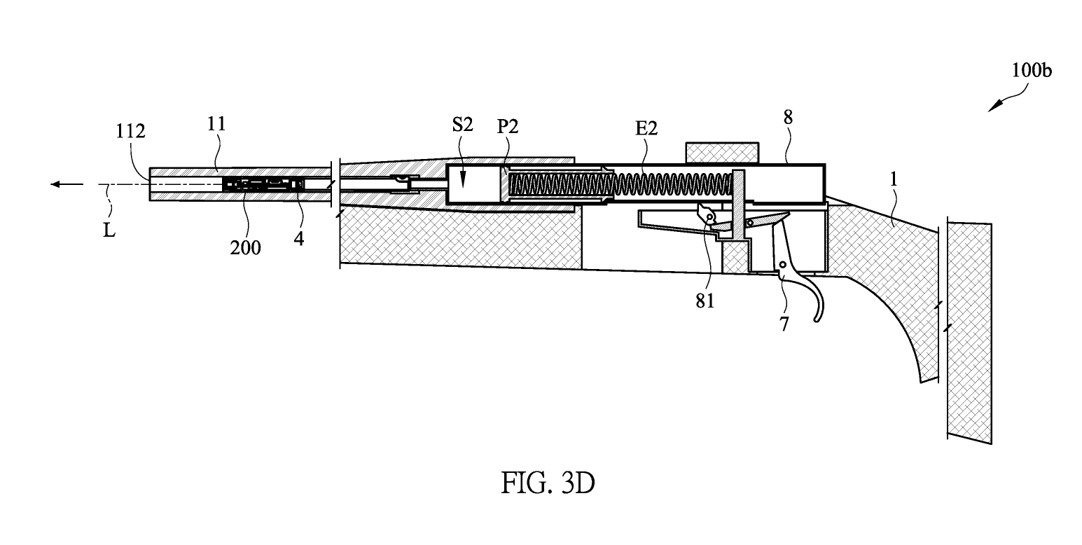

Referring to FIGS. 3A-3D, similar to the laser gun 100a, in an embodiment, a laser gun 100b is operated through manually pulling a slidable sleeve 8 in order to move the driving piston P2 backwards and compress the spring E2. As shown in FIG. 3A, an initial or home condition of the laser gun 100b is illustrated. Through manually pulling the slidable sleeve 8, the driving piston P2 is forced backwards and compressing the spring E2, as shown in FIG. 3B. The driving piston P2, when moved backwards to a predetermined location, gets in engagement with and retained by a retaining member 81 and under this condition, releasing and manually pushing the slidable sleeve 8 to make the slidable sleeve 8 return would form a connection space S2, as shown in FIG. 3C. When a shooter pulls the trigger plate 7, the retaining member 81 is caused to disengage from the driving piston P2, allowing the spring E2 to be released and thus causing the driving piston P2 to move forwards, as shown in FIG. 3D, to compress gas or air contained in the connection space S2 formed through communicating connection between the jointing assembly 3 and the gun body 1 so that the driving force (a pneumatic driving force) is supplied, in the form of compressed gas, to push the pressing member 4 for emission of the laser beam L.

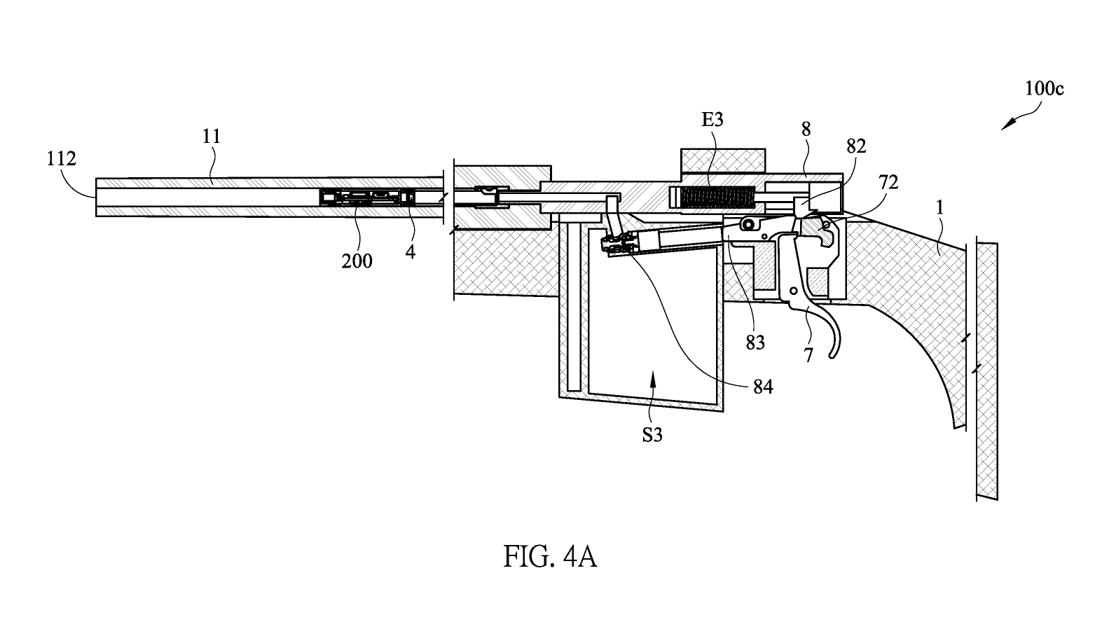

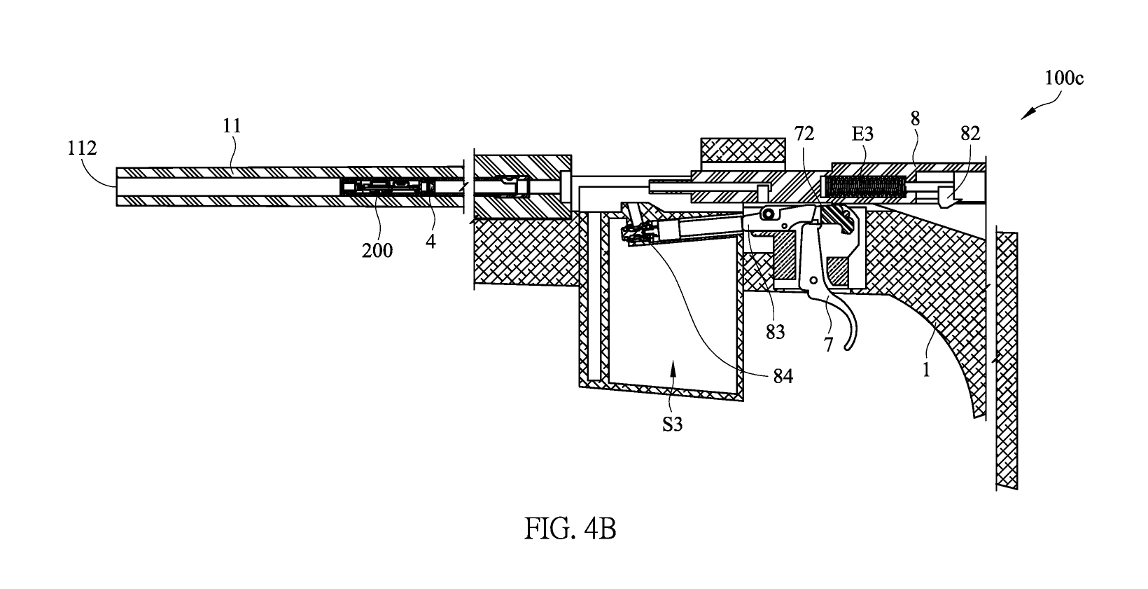

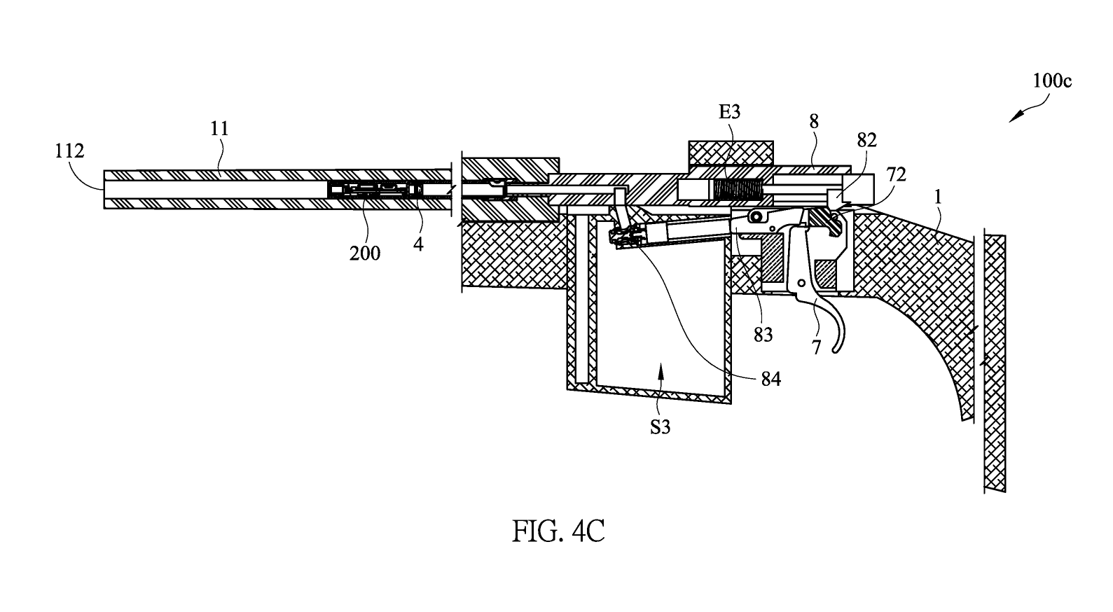

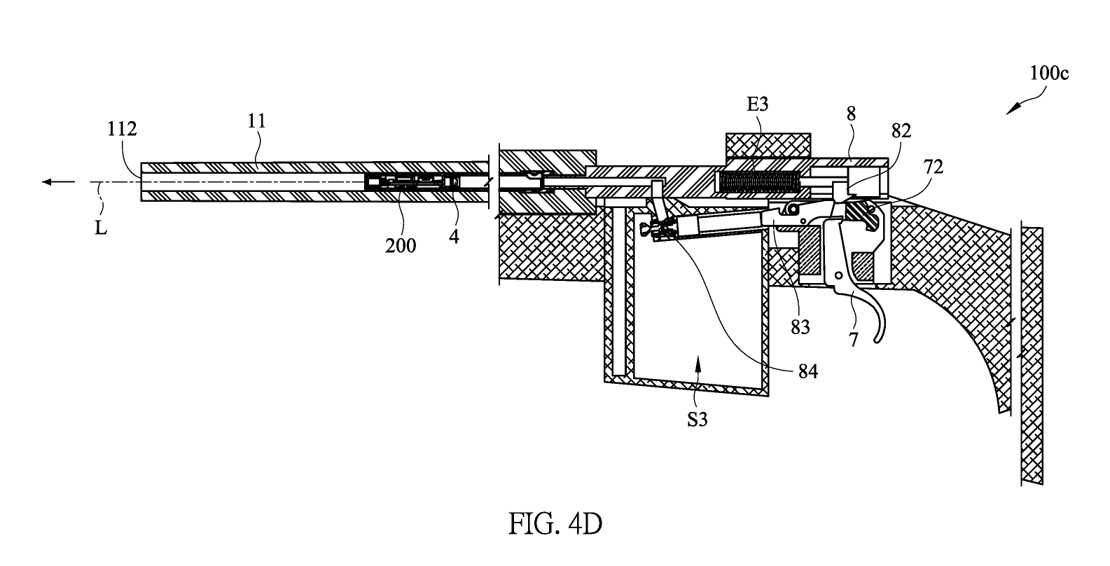

Referring to FIGS. 4A-4D, in an embodiment, gas or air (such as pressurized gas) that is contained in another gas accommodation space S3 is applied to provide the driving force. As shown in FIG. 4A, an initial or home condition of a laser gun 100c is illustrated. Manually pulling a slidable sleeve 8 causes a striker pin 82 to move backwards, as shown in FIG. 4B. The backwards movement of the slidable sleeve 8 compresses the spring E3, and under this condition, releasing or manually pushing the slidable sleeve 8 to make the slidable sleeve 8 return, the striker pin 82 is retained by a retaining member 72 so as to keep the spring E3 compressed, as shown in FIG. 4C. When a shooter pulls the trigger plate 7, the retaining member 72 is caused to rotate and thus allowing the striker pin 82 to disengage from being retained by the retaining member 72 and caused to move forwards by a restoration force of the spring E3 thereby making the striker pin 82 strike a gas valve firing pin 83 and opening a gas valve 84, as shown in FIG. 4D, allowing gas contained in the gas accommodation space S3 to pass through the gas valve 84 and thus passing through a connection space formed through communicating connection between the gun barrel 11 and the jointing assembly 3 so that the driving force (a pneumatic driving force) is supplied, in the form of gas, to push the pressing member 4 for emission of the laser beam L.

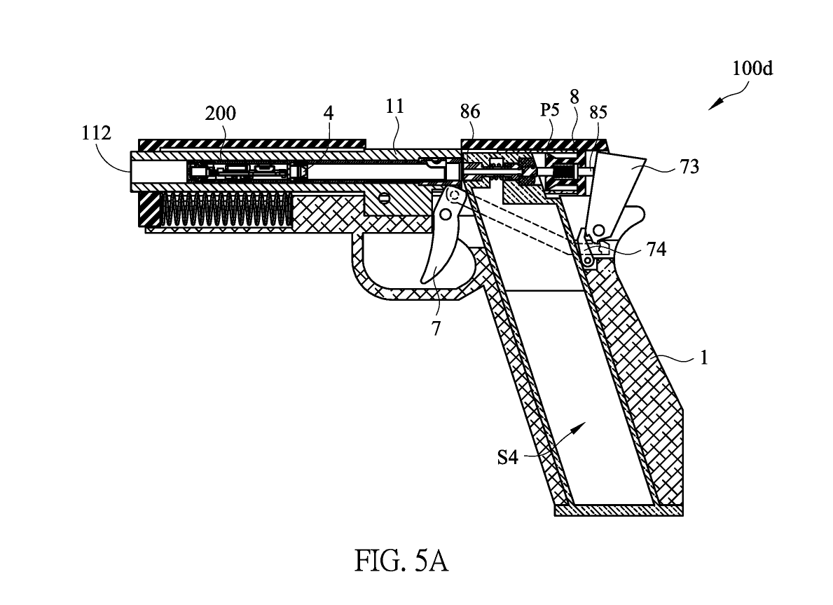

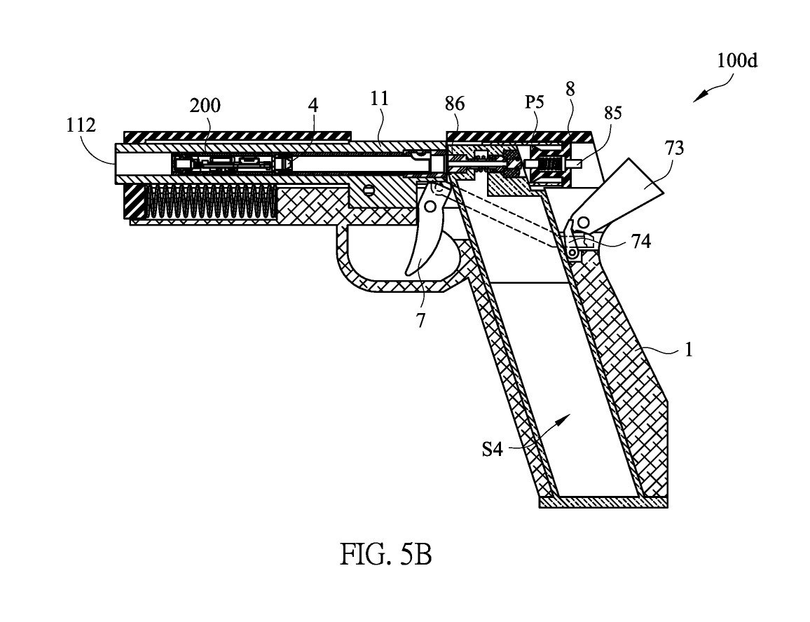

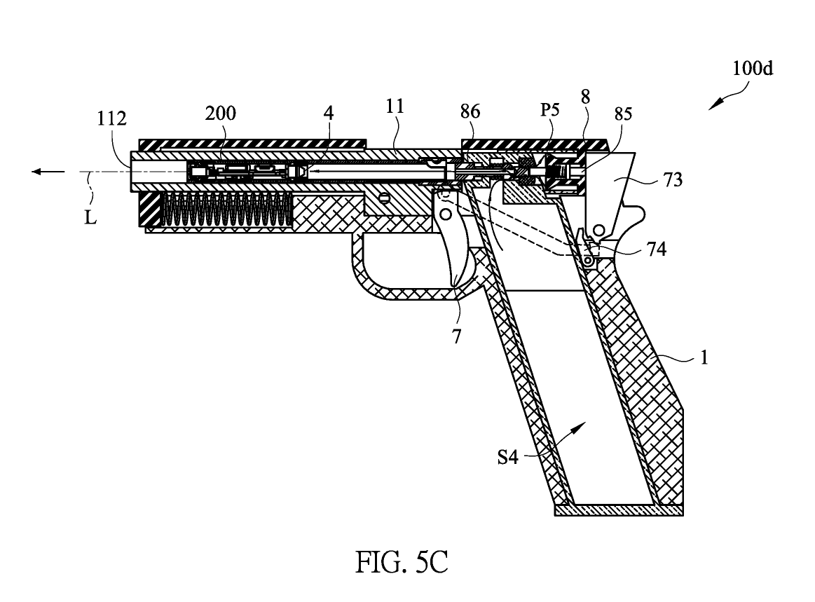

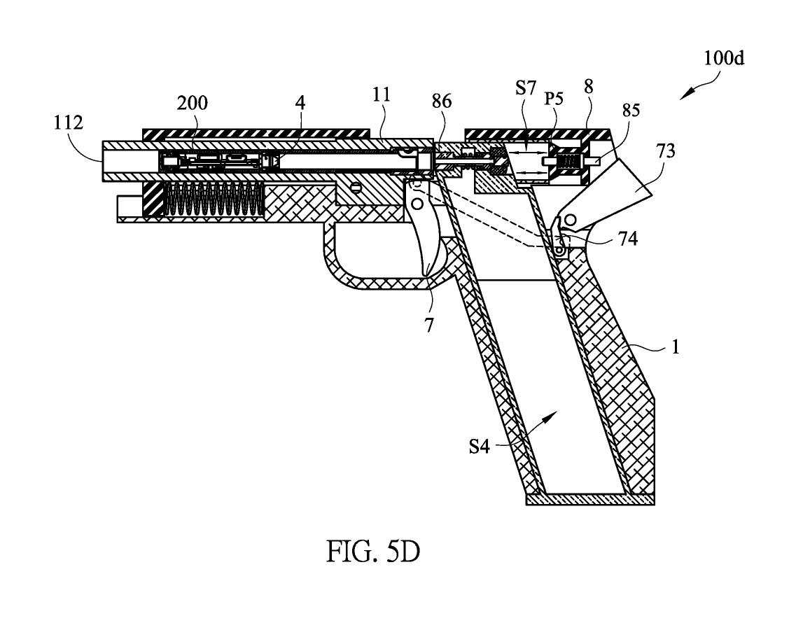

Referring to FIGS. 5A-5D, more similar to the laser gun 100c, in an embodiment, a laser gun 100d is operated by pulling the trigger plate 7 to cause a striker 73 to strike the gas valve striker pin 85 to open a gas valve 86 for supplying gas to provide the driving force. As shown in FIG. 4A, an initial or home condition of a laser gun 100d is illustrated. Manually pulling the striker 73 to such an extent that the striker 73 is retained by a retaining member 74 and thus staying in a ready-to-strike position, as shown in FIG. 5B. When a shooter pulls the trigger plate 7, the retaining member 74 is caused to rotate and thus allowing the striker 73 to disengage from being retained by the retaining member 74, making the striker 73 strike the gas valve striker pin 85 to open the gas valve 86, as shown in FIG. 4c, allowing gas (such as pressurized gas) contained in a gas accommodation space S4 to pass through the gas valve 86 and thus passing through a connection space formed through communicating connection between the gun barrel and the jointing assembly 3 so that the driving force (a pneumatic driving force) is supplied, in the form of gas, to push the pressing member 4 for emission of the laser beam L, as shown in FIG. 5C. Preferably, when the gas of the gas accommodation space S3 passes through the gas valve 86, a part of the gas enters a gas space S7. The laser gun 100d further comprises a pneumatic piston P5 and the pneumatic piston P5 is connected with a slidable sleeve 8, so that such a part of gas entering the gas space S7 (being a pneumatic driving force) forces the pneumatic piston P5 backwards to achieve an effect of expansion of the gas space S7 thereby making the slidable sleeve 8 move backwards to press against the striker 73 so as to have the striker 73 engaging and retained by the retaining member 74 for automatic return to the ready-to-strike position, as shown in FIG. 5D. Afterwards, the slidable sleeve 8 will automatically return due to the restoration force of the spring E4 contained therein.

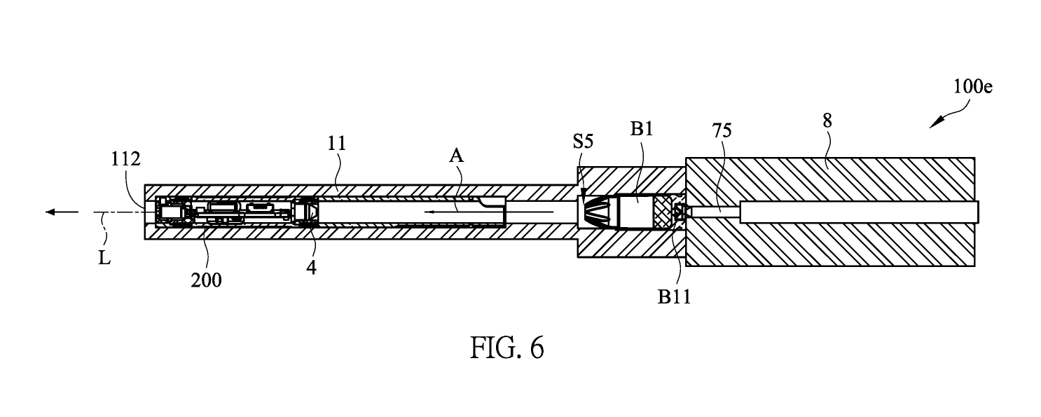

Referring to FIG. 6, in an embodiment, a laser gun 100e has a chamber S5 in which gun powder contained in a blank cartridge B1 is allowed to quick burning to generate high pressure gas (this being referred to as explosion hereinafter) to provide the driving force. Further, a firing pin 75 is movable forwards to strike primer B11 of the blank cartridge B1 to cause explosion of the blank cartridge B1. During the explosion of the blank cartridge B1, a gas flow A having a sufficient pressure is generated to flow towards the pressing member 4. The gas flow A provides a driving force (pneumatic driving force) to push the pressing member 4 for emission of the laser beam L. Further, during the explosion of the blank cartridge B1, the gas pressure so generated also causes the blank cartridge B1 to move backward so as to drive the slidable sleeve 8 connected with the firing pin 75 backwards.

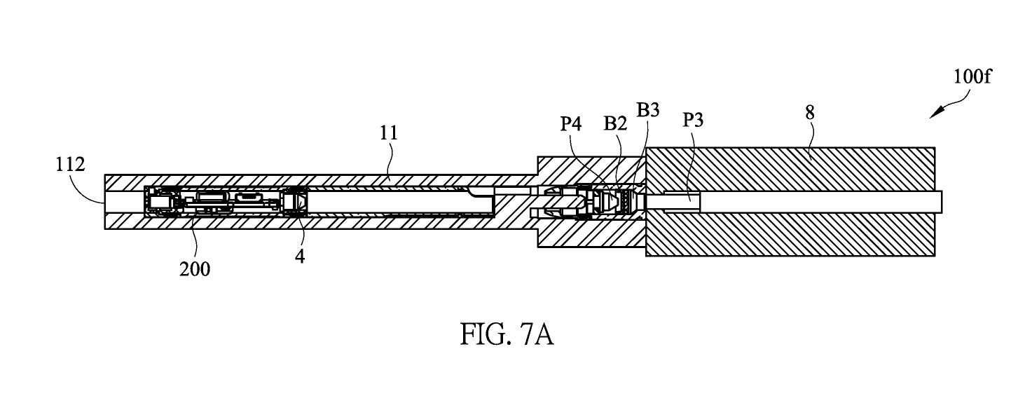

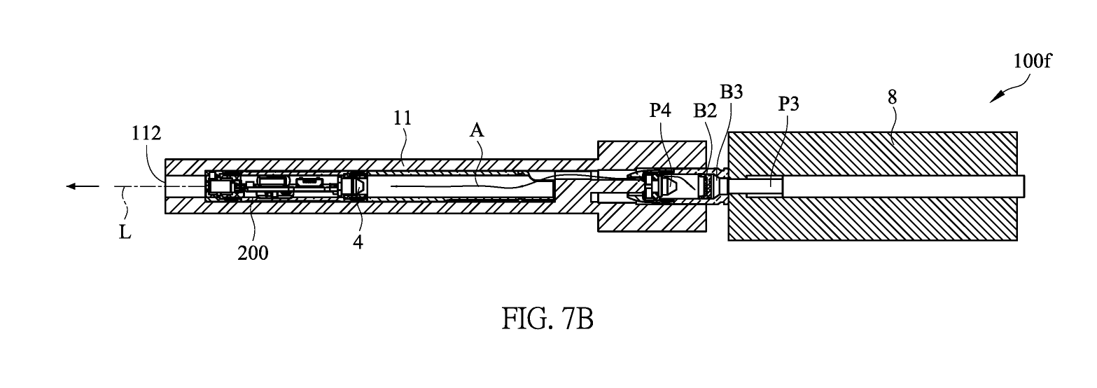

Referring to FIGS. 7A and 7B, in an embodiment, a laser gun 100f is operated by having gun powder B2 exploding to provide a driving force. More specifically, the gun powder B2 is arranged on a gun powder plunger B3 and with a push bar P3 moved forwards, the gun powder B2 is compressed between the gun powder plunger B3 and a compression bar P4 to cause explosion of the gun powder B2, as shown in FIG. 7A. During the explosion of the gun powder B2, a gas flow A having a sufficient pressure is generated to flow towards the pressing member 4. The gas flow A provides a driving force (pneumatic driving force) to push the pressing member 4 for emission of the laser beam L. Further, during the explosion of the gun powder B2, the gas pressure so generated also causes the gun powder plunger B3 and the push bar P3 to move backwards (acting like a pneumatic piston) so as to drive the slidable sleeve 8 connected with the push bar P3 backwards, as shown in FIG. 7B.

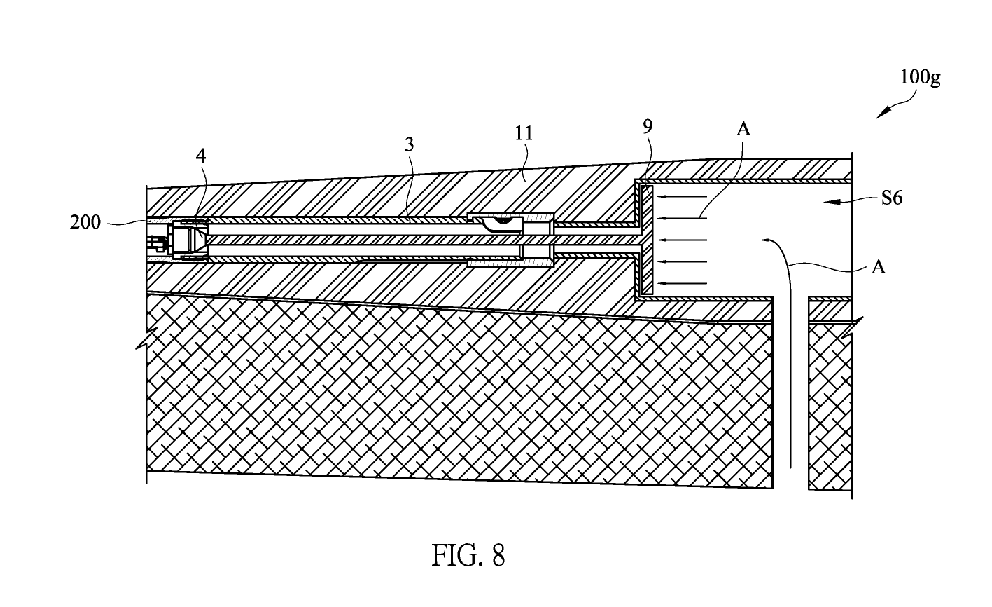

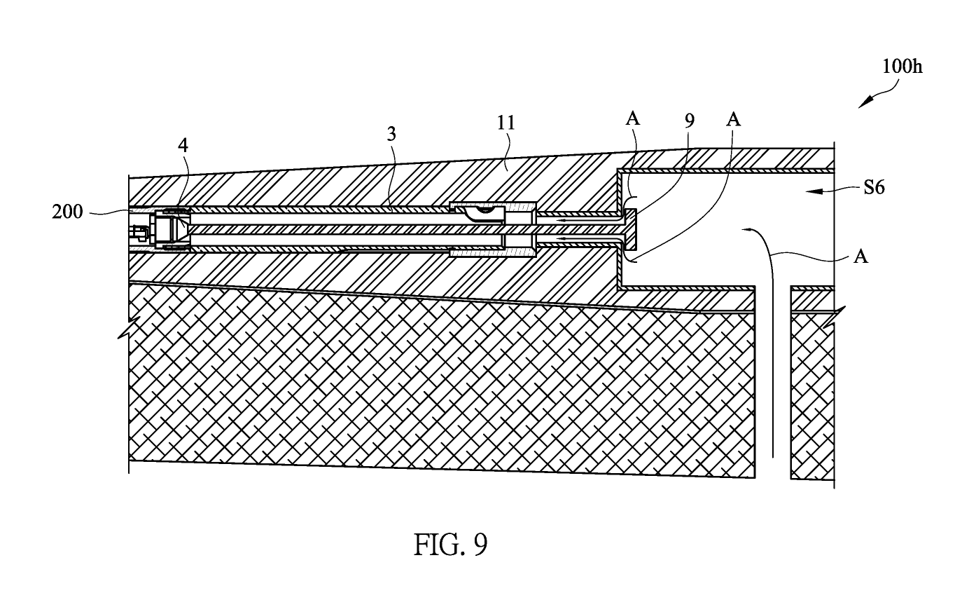

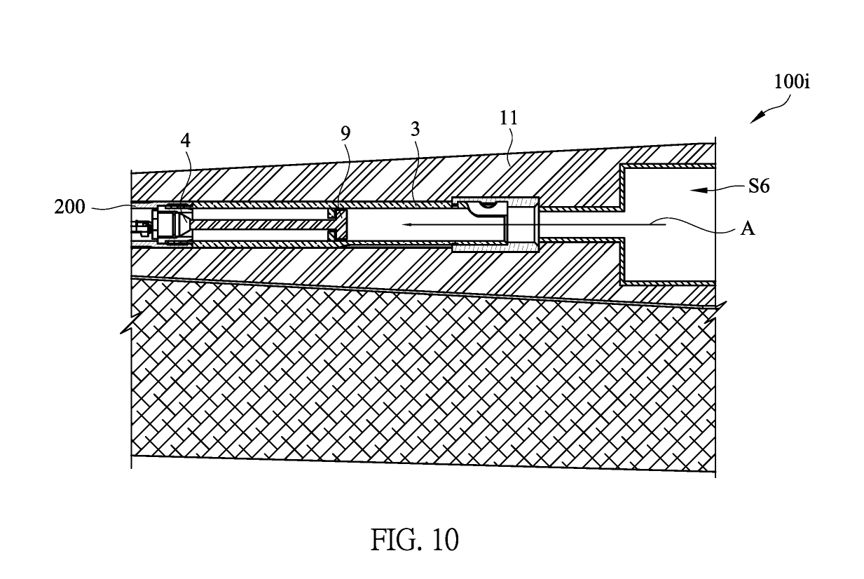

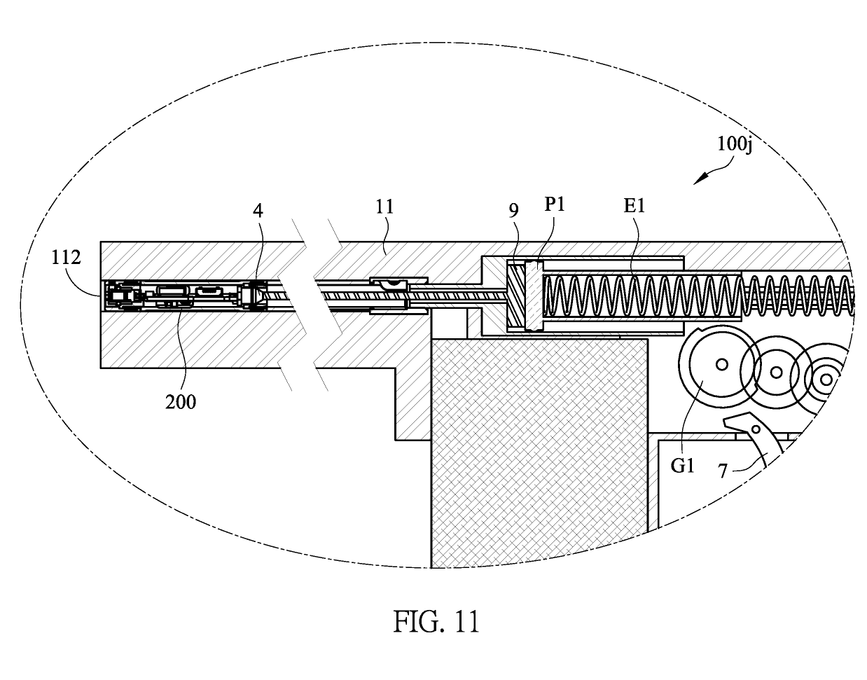

In a preferred embodiment, as shown in FIG. 8, a slidable pushing member 9 is slidably arranged in a connection space S6 formed through communicating connection between the jointing assembly 3 and the gun body 1 of the laser gun 100g. The slidable pushing member 9 receives and is acted upon by a gas flow A from the connection space S6 (such as pressurized gas supplied from a gas accommodation space or an air or gas flow generated due to movements of a driving piston P1, P2 as described in the previous embodiment) to slide toward the pressing member 4 to push the pressing member 4 for emission of the laser beam L (FIG. 3), and under this condition, the gas flow A provides a positive pressure pneumatic pushing force acting on the slidable pushing member 9. However, the present invention is not limited to such an arrangement and in other embodiments, the gas flow A may be allowed to move forwards through a gap around the slidable pushing member 9 so that the high flow speed of the gas flow A passing through the gap around the slidable pushing member 9 results in a low pressure that induces a negative pressure pneumatic suction force acting on the slidable pushing member 9, such as a laser gun 100h shown in FIG. 9, so that the slidable pushing member 9 is caused to slide towards the pressing member 4 to push the pressing member 4 for emission of the laser beam L (FIG. 3). In other embodiments, the slidable pushing member 9 can be arranged in the jointing assembly 3 only, such as a laser gun 100i shown in FIG. 10, to receive and be acted upon by a gas flow A from the connection space S6 for sliding towards the pressing member 4 and thus pushing the pressing member 4. Similar to the laser gun g or the laser gun 100h, in the laser gun 100i, the gas flow A may be arranged to provide either a positive pressure pneumatic pushing force or a negative pressure pneumatic suction force acting on the slidable pushing member 9. Of course, the present invention is not limited to these arrangements and for example, the slidable pushing member 9 can be arranged in the connection space S1, S2 provided in the previous embodiment and may also receive or be acted upon by a gas flow from the connection space S1, S2 to slide towards the pressing member 4 to achieve an effect of pushing the pressing member 4. Or alternatively, the slidable pushing member 9 can be driven through mechanical physical contact (direct contact) by the driving piston P1 to slide towards the pressing member 4 to push the pressing member 4 (mechanical driving force), such as a laser gun 100j shown in FIG. 11. Or alternatively, in other embodiments, the slidable pushing member 9 can be driven through mechanical physical contact by a driving piston (a mechanical driving force) and also driven by a gas flow caused by a movement of a driving piston (a pneumatic driving force) to slide towards the pressing member 4 to push the pressing member 4.

Further, similarly, in the modified embodiments illustrated in FIGS. 8, 9, and 10, a pneumatic piston may be additionally included to be slidably arranged in a rear opening of a connection space S6 formed through communicating connection between the jointing assembly 3 and the gun body 1. The pneumatic piston is connected with a slidable sleeve and may receive a pneumatic driving force induced by a gas flow A to acted thereon for driving the slidable sleeve backwards.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A laser mechanism for shooting training, which is coupled with a gun body, the laser mechanism comprising:
a laser assembly, which comprises a laser emitter and a laser activator electronically connected with the laser emitter;
a jointing assembly, which is detachably mounted in a gun barrel of the gun body; and
a pressing member, which is slidably arranged at a front end of the jointing assembly at a location adjacent to and corresponding to the laser activator, the pressing member receiving a driving force applied from the gun body to act thereon to slide towards the laser activator and thus pressing against the laser activator, so as to cause the laser activator to trigger and activate the laser emitter to emit a laser beam, wherein the driving force is a pneumatic driving force and/or a mechanical driving force.

2. The laser mechanism according to claim 1, wherein the jointing assembly comprises a stop section that is engageable with and thus stopping a stopped section of the pressing member in the sliding of the pressing member.

3. The laser mechanism according to claim 1, wherein the laser assembly is arranged in an extended jointing assembly, the extended jointing assembly being coupled to coupling section of a front end of the jointing assembly and extending toward a muzzle of the gun barrel.

4. The laser mechanism according to claim 3, wherein the extended jointing assembly comprises a top lid and a bottom base, the laser assembly being fixed to the top lid and the bottom base by fasteners.

5. The laser mechanism according to claim 3, wherein the extended jointing assembly comprises a first positioning shell and a second positioning shell, the first positioning shell and the second positioning shell being coupled to and encompassing the laser emitter so as to retain the laser emitter in position.

6. The laser mechanism according to claim 5, wherein the first positioning shell and the second positioning shell are interposed between a disposition tube and a sleeve.

7. The laser mechanism according to claim 1, wherein the jointing assembly has a hollow configuration and is in communication with the gun body to form a connection space.

8. The laser mechanism according to claim 1, wherein the jointing assembly comprises a positioning section, which is positionable against a positioning piece of the gun barrel.

9. A laser gun for shooting training, the laser gun comprising a gun body having a gun barrel in which a laser mechanism according to claim 1 is received and mounted.

10. The laser gas according to claim 9 further comprising a driving piston, which provides, through mechanical contact or pressurized gas, the driving force to push the pressing member.

11. The laser gas according to claim 9 further comprising a slidable pushing member, which is slidably arranged in the jointing assembly or is slidably arranged in a front opening of a connection space formed through communicating connection between the jointing assembly and the gun body, the slidable pushing member receiving a gas flow from the connection space to act thereon so as to slide towards the pressing member to push the pressing member, wherein the gas flow is in the form of a positive pressure pneumatic pushing force or a negative pressure pneumatic suction force acting on the slidable pushing member.

12. The laser gas according to claim 9 further comprising a pneumatic piston, the pneumatic piston being connected with a slidable sleeve and acted by the pneumatic driving force to drive the slidable sleeve backwards.
